(19) United States
(12) Patent Application Publication
(10) Pub. No.: US 2017/0232535 A1
(43) Pub. Date: Aug. 17, 2017

(54) ARCHERY ARROW WET SAW AND METHOD

(71) Applicant: Last Chance Archery LLC, Pendergrass, GA (US)

(72) Inventor: Leon Monroe Pittman, Pendergrass, GA (US)

(21) Appl. No.: 15/433,725

(22) Filed: Feb. 15, 2017

Related U.S. Application Data
(60) Provisional application No. 62/389,034, filed on Feb. 16, 2016.

(51) Int. Cl. B23D 59/00; B23D 47/02; B23D 59/02

(52) U.S. Cl. CPC B23D 59/006; B23D 59/025; B23D 47/02; B23D 59/001; F42B 6/04

(57) ABSTRACT

An arrow saw includes a blade misting arrangement that provides for control and removal of carbon particulate. The arrow saw includes a base with a mounted motorized saw and an arrow tip support that supports the tip of the archery arrow while cutting. The saw includes a hood enclosing the blade with a misting nozzle for generating a mist within the hood during cutting operations. The mist captures particulate generated during the cutting operation and a vacuum system is connected to the hood to remove the wetted particulate. The arrow saw also has a pressurized water supply inlet coupled to a misting nozzle on the hood for providing a source of pressurized water to the misting nozzle.

This U.S. patent application claims priority under 35 U.S.C. §119 to U.S. Provisional Patent Application Ser. No. 62/389,034 filed on Feb. 16, 2016.

### BACKGROUND OF THE INVENTION

1. Field of the Invention

The present invention relates generally to equipment for cutting archery arrow shafts, and more particularly, to an arrow saw including misting and particulate removal features.

2. Description of the Related Art

The fabrication of archery arrows requires cutting the arrow shaft to size prior to fletching. Present-day materials used for arrow shafts are typically carbon composite materials, which, when cut, generate carbon dust, as well as other dust particles that are harmful when inhaled or contact the skin. The abrasive blades typically used to cut arrow shafts also generate particulate that may be harmful when inhaled.

Typical saws used to cut arrow shafts incorporate dust collectors, but are ineffective to totally capture fine particulate generated by an arrow shaft cutting operation. Further, disposing of the collected dust presents a health hazard. Wet saws are available for cutting other materials such as tile, but are inappropriate for the abrasive saw blades used to cut arrow shafts.

Therefore, it would be desirable to provide a arrow saw that can safely cut arrow shafts while reducing generation of harmful particulate and facilitating particulate capture.

### SUMMARY OF THE INVENTION

The objective of providing an arrow saw that effectively and safely captures arrow shaft and saw blade particulate is provided in an arrow saw and its method of operation.

The arrow saw includes a base, a motorized saw mounted to a first end of the base, an arrow tip support mounted along the base for supporting a tip of the archery arrow and a hood extending over a blade mounting area of the motorized saw. A misting nozzle is affixed to the hood and extends into the hood for generating a mist within the hood during a cutting operation for capturing particulate generated during the cutting operation. The arrow saw also has a pressurized water supply inlet coupled to the misting nozzle for providing a source of pressurized water to the misting nozzle, and a collector for collecting the particulate and the water during the cutting operation.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIG. 1A is a top view and FIG. 1B is a side view of an example arrow saw 10.

FIG. 2 is a top view of arrow saw 10 with an arrow shaft 5 mounted for cutting.

FIG. 3 is a top view of arrow saw 10 with external system attachments.

FIG. 4 is a front view of arrow saw 10.

FIGS. 5A and 5B are block diagrams of different water supply arrangements that can be used with arrow saw 10.

### DESCRIPTION OF ILLUSTRATIVE EMBODIMENT

The present disclosure reveals a wet saw for cutting archery arrow shafts that captures the carbon particulate generated by cutting the arrow shafts. A misting nozzle is provided within a hood enclosing the saw blade except in a narrow cutting area through which the arrow shaft is introduced. A vacuum connection and optional drip tray and drain collect the wetted particulate.

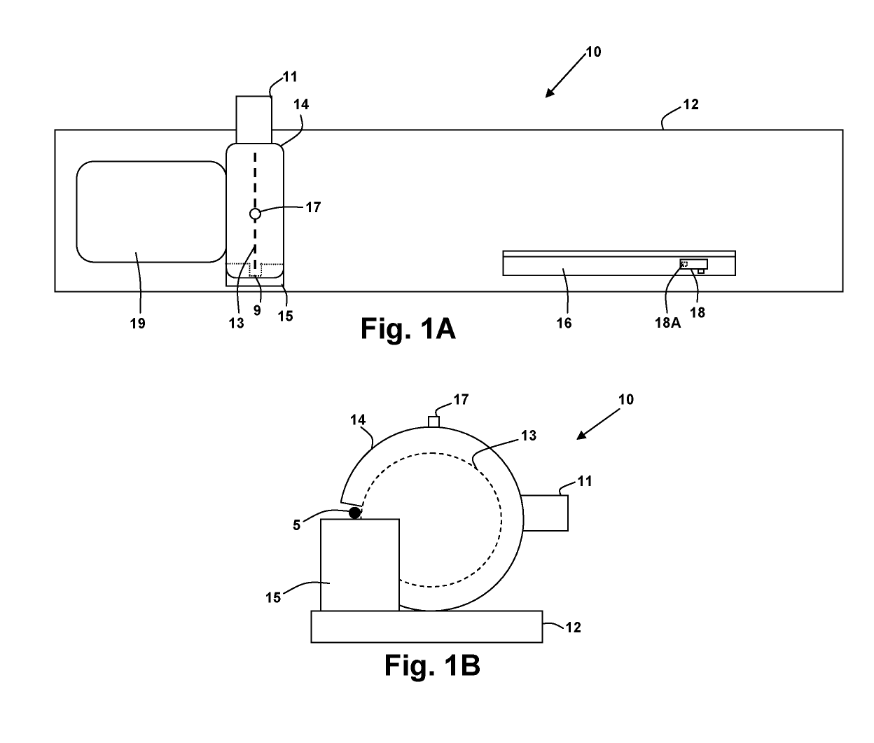

Referring now to FIG. 1A and FIG. 1B, an example arrow saw 10 is shown in a top view and side view, respectively. In the illustration, a motorized saw including a motor 19 has a circular blade 13 mounted to a blade mounting fixture and is mounted to a base 12 that supports components of the arrow saw. A shroud 14 encloses blade 13 and has a vacuum port 11 configured for connection of a standard shop vacuum hose, generally a 2″ or greater diameter hose. A sliding table 15 is slideably mounted to base 12 at a bottom side of sliding table 15 and provides a gap 9 through which circular blade 13 passes when sliding table 15 is slid toward circular blade 13 to perform the cutting operation. A misting nozzle 17 provides droplets that form a mist, e.g., droplets of between 0.01 and 0.1 mm diameter that wets blade and an arrow shaft 5 being cut during the cutting operation. The mist droplets capture the carbon particles generated by cutting arrow shaft 5 and are removed by suction provided at vacuum port 11. An arrow tip support 16 includes a tip block 18 that is slideably mounted on arrow tip support 16 and sets the desired length of a cut arrow shaft. A recess 18A is provided in tip block 18 to accommodate the tip of arrow shaft 5 (not shown in FIG. 1A for clarity).

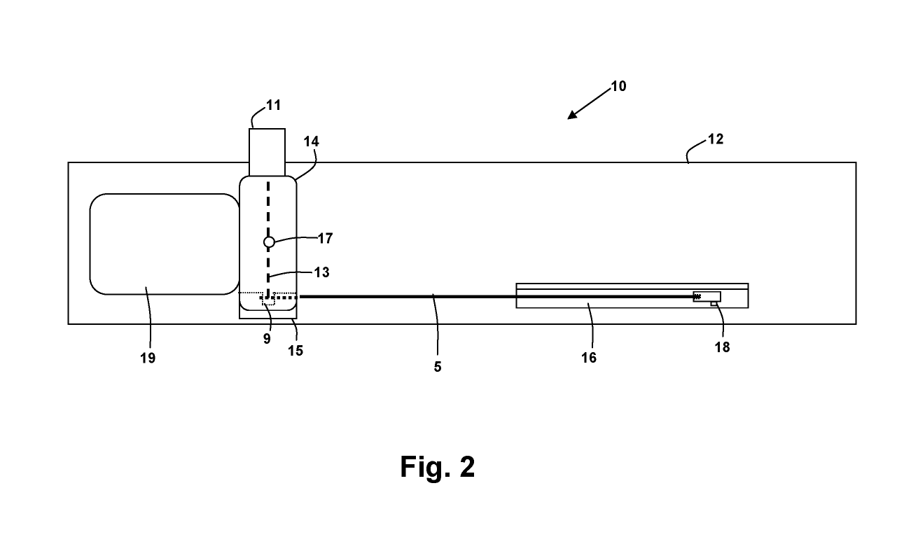

Referring now to FIG. 2, arrow shaft 5 is shown mounted between tip block 18 and sliding table 15 in the top view of arrow saw 10. To cut arrow shaft 5, the position of tip block 18 is set along arrow tip support 16 to provide a predetermined arrow length between circular blade 13 and the end of recess 18A within tip block 18. Motor 19 is activated, pressurized water is supplied to misting nozzle 17 and suction is applied to vacuum port 11. Sliding table 15 is slid forward until arrow shaft 5 is partially cut (approximately ⅓ of the diameter of arrow shaft 5 has been penetrated by circular blade 13). Then, arrow shaft 5 is rotated until the cut is extended completely around arrow shaft 5, which provides an even cut around arrow shaft 5. The excess material of arrow shaft 5 generally breaks away or can be easily removed by hand.

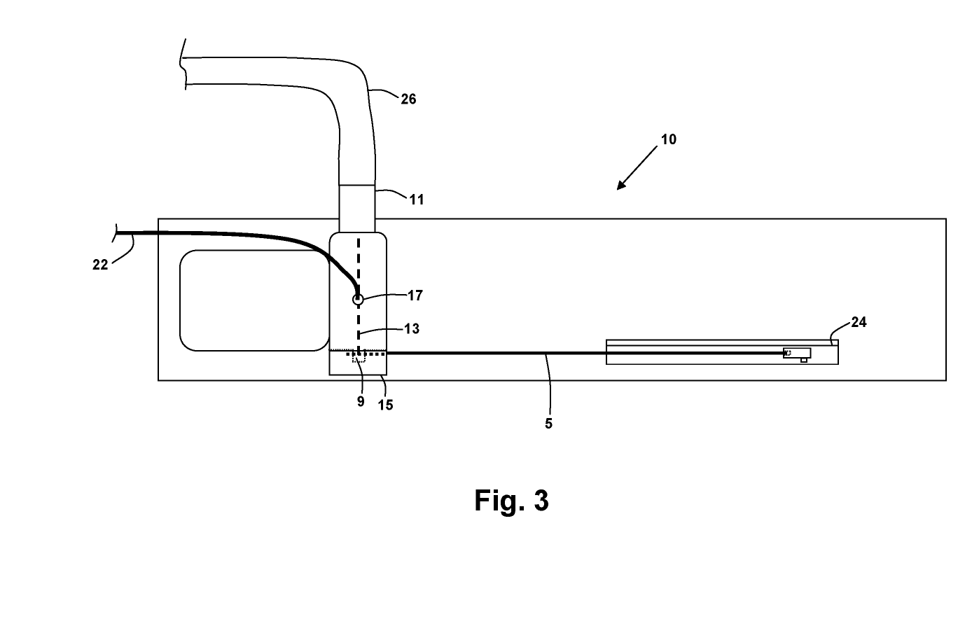

FIG. 3 shows a top view of arrow saw 10 with a vacuum hose 26 attached and which can be coupled at the other end to a standard shop vacuum that is activated during cutting operations. FIG. 3 also shows a water supply line 22 connected to misting nozzle 17 and to which a constant pressure is supplied during cutting operations. The water supply, suction and motor 19 may all be controlled via a common power switch, or may be manually operated by the saw operator.

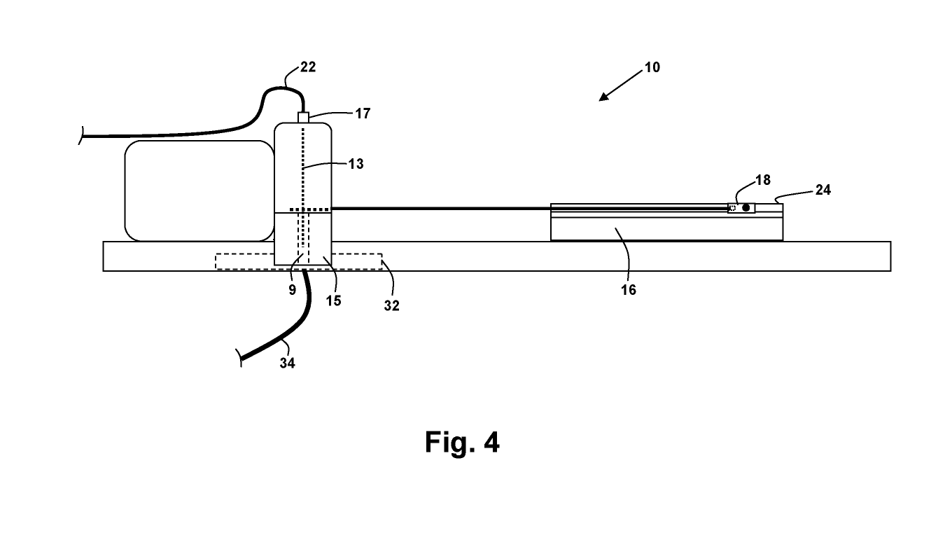

FIG. 4 shows a front view of arrow saw 10. In addition to vacuum port 11 described above, arrow saw 10 will generally include a drain tray 32 to collect water droplets and carbon particulate that are not removed through vacuum port 11. A drain hose 34 is provided to drain to a larger reservoir for disposal of the liquid waste containing the carbon particulate. FIG. 4 also shows the track 24 along which tip block 18 moves when adjusted.

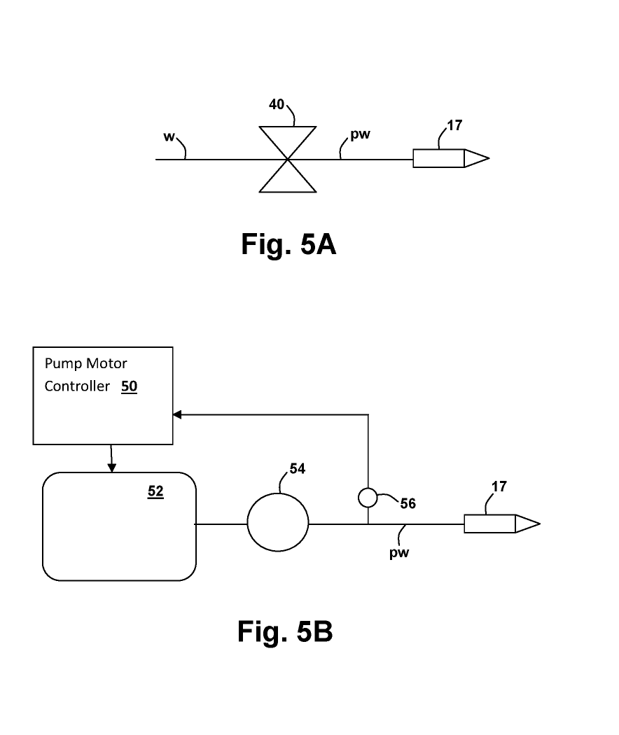

FIG. 5A and FIG. 5B show different alternative water supply arrangements that can be used with arrow saw 10. FIG. 5A illustrates a pressure regulating valve 40 used to condition an input water supply W, generally provided from a standard water mains supply at a pressure greater than 100 psi. Pressure regulating valve 40 has a manual shut-off, or optionally an electrical shut-off as mentioned above, and an adjustment for setting the predetermined water pressure of pressurized water PW supplied to misting nozzle 17. FIG. 5B illustrates an alternative configuration in which a water tank 52 supplies water to a pump 54 that pumps pressurized water PW to misting nozzle 17. A pressure sensor 56 provides a signal to a pump motor controller 50 to regulate the pressure of pressurized water PW during operation. As mentioned above, pump motor controller 50 can be activated by a switching arrangement that energizes motor 19 of arrow saw 10.

While the invention has been particularly shown and described with reference to the preferred embodiment thereof, it will be understood by those skilled in the art that the foregoing and other changes in form, and details may be made therein without departing from the spirit and scope of the invention.

What is claimed is:

1. A machine for cutting a shaft of an archery arrow, comprising:
a base;
a motorized saw mounted to the base at a first end of the base;
an arrow tip support mounted along the base for supporting a tip of the archery arrow;
a hood extending over a blade mounting area of the motorized saw;
a misting nozzle affixed to the hood and extending into the hood for generating a mist within the hood during a cutting operation for capturing particulate generated during the cutting operation;
a pressurized water supply inlet coupled to the misting nozzle for providing a source of pressurized water to the misting nozzle; and
at least one collector for collecting the particulate during the cutting operation.

2. The machine of claim 1, wherein the misting nozzle is affixed to a first side of the hood facing a first side of a blade mounted in the motorized saw, wherein the first side of the blade faces toward the arrow tip support.

3. The machine of claim 2, wherein the at least one collector includes a tray for collecting water and particulate suspended in the water beneath the blade.

4. The machine of claim 3, wherein the at least one collector further includes a vacuum port disposed on a second side of the hood for removing particulate and water during the cutting operation.

5. The machine of claim 1, further comprising a pressure regulator for regulating a pressure of water supplied by the pressurized water source.

6. The machine of claim 1, further comprising:
a water tank; and
a pump for supplying the source of pressurized water to the misting nozzle from the water tank.

7. The machine of claim 6, further comprising:
a pressure sensor coupled to an outlet of the pump; and
a pump motor controller for controlling a motor of the pump in conformity with an output of the pressure sensor to maintain a predetermined pressure of the pressurized water supplied to the misting nozzle.

8. The machine of claim 1, further comprising a shaft end table slideably mounted to the base proximate the blade mounting area of the motorized saw and defining a slot through which a blade mounted to the motorized saw extends when the shaft end table is slid toward the blade.

9. A machine for cutting a shaft of an archery arrow, comprising:
a base;
a motorized saw mounted to the base at a first end of the base and having a blade mounted thereto;
a shaft end table slideably mounted to the base proximate the blade mounting area of the motorized saw and defining a slot through which a blade mounted to the motorized saw extends when the shaft end table is slid toward the blade;
an arrow tip support mounted along the base for supporting a tip of the archery arrow;
a hood extending over a blade mounting area of the motorized saw;
a misting nozzle affixed to the hood and extending into the hood for generating a mist within the hood during a cutting operation for capturing particulate generated during the cutting operation;
a pressurized water supply inlet coupled to the misting nozzle for providing a source of pressurized water to the misting nozzle; and
a vacuum port disposed on a second side of the hood for removing particulate during the cutting operation.

10. The machine of claim 9, further comprising a pressure regulator for regulating a pressure of water supplied by the pressurized water source.

11. A method of cutting a shaft of an archery arrow, comprising:
providing a motorized saw mounted to a base at a first end of the base;
supporting a tip of the archery arrow with an arrow tip support mounted along the base;
enclosing a blade mounted to the motorized saw with a hood;
generating a water mist with a misting nozzle affixed to the hood and extending into the hood during a cutting operation for capturing particulate generated during the cutting operation;
providing a source of pressurized water to the misting nozzle; and
collecting the particulate during the cutting operation with at least one collector.

12. The method of claim 11, wherein the misting nozzle is affixed to a first side of the hood facing a first side of the blade mounted in the motorized saw, wherein the first side of the blade faces toward the arrow tip support.

13. The method of claim 12, wherein the at least one collector includes a tray for collecting water and particulate suspended in the water beneath the blade.

14. The method claim 13, wherein the collecting comprises collecting the particulate by suction provided at a vacuum port disposed on a second side of the hood.

15. The method of claim 11, wherein the providing the source of pressurized water comprises regulating a pressure of water supplied by a pressurized water source with a pressure regulator.

16. The method of claim 11, wherein the providing the source of water comprises:
providing water in a water tank; and
pumping the water from the water tank to the misting nozzle with a pump to supply the pressurized water.

17. The method of claim 26, further comprising:
sensing pressure of the water pumped from the water tank with a pressure sensor coupled to an outlet of the pump; and
controlling a motor of the pump in conformity with an output of the pressure sensor to maintain a predetermined pressure of the pressurized water supplied to the misting nozzle.

18. The method of claim 11, further comprising:
providing a shaft end table slideably mounted to the base proximate the blade mounting area of the motorized saw and defining a slot through which a blade mounted to the motorized saw extends when the shaft end table is slid toward the blade; and
sliding the shaft end table toward the blade to cut the arrow shaft.
